(19) United States
(12) Patent Application Publication
(10) Pub. No.: US 2017/0322824 A1
(43) Pub. Date: Nov. 9, 2017

(54) Cloning Computing Device Containers

(71) Applicant: Microsoft Technology Licensing, LLC, Redmond, WA (US)

(72) Inventors: Lars Reuther, Kirkland, WA (US); David A. Hepkin, Redmond, WA (US); Kevin M. Broas, Kirkland, WA (US); John A. Starks, Seattle, WA (US); Arun U. Kishan, Kirkland, WA (US); John J. Richardson, Coupeville, WA (US); Mehmet Iyigun, Kirkland, WA (US); Yevgeniy M. Bak, Redmond, WA (US)

(73) Assignee: Microsoft Technology Licensing, LLC, Redmond, WA (US)

(21) Appl. No.: 15/280,201

(22) Filed: Sep. 29, 2016

Related U.S. Application Data
(60) Provisional application No. 62/332,220, filed on May 5, 2016.

(51) Int. Cl. G06F 9/455; G06F 3/06

(52) U.S. Cl. CPC G06F 9/45558; G06F 3/0665; G06F 3/0632; G06F 3/0683; G06F 3/0604; G06F 3/065; G06F 2009/45562; G06F 2009/45583

(57) ABSTRACT

An operating system running on a computing device, also referred to herein as a host device, uses containers for hardware resource partitioning. A container can include one or more of various different components, such as a base operating system, a user-mode environment, an application, virtual devices, combinations thereof, and so forth. One or more container templates are maintained for a computing device, and in response to a request to create a new container, a template container is copied into memory of the computing device to create the new container. The template container includes the various components of the container, and these components are copied into memory of the computing device rather than being launched or started one after the other. Thus, time need not be expended starting the various components included in the container—the components are just copied into memory as a new container.

### RELATED APPLICATIONS

This application claims priority to U.S. Provisional Application No. 62/332,220, filed May 5, 2016, entitled “Cloning Computing Device Containers”, to Lars Reuther, et al.

### BACKGROUND

Operating systems can use hardware resource partitioning to share hardware resources among multiple different virtual machines or containers. While such sharing can increase the number of processes or virtual machines deployed on a device, such sharing is not without its problems. One such problem is that management of hardware resources during such sharing can be difficult, which can degrade the performance of the virtual machines or containers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a request to create a container in a computing device is received. A template container is copied into memory of the computing device to create a new container, and the new container is started in response to the request.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the cloning computing device containers in accordance with one or more embodiments.

FIGS. 2 and 3 illustrate examples of containers.

FIG. 4 is a flowchart illustrating an example process for cloning computing device containers in accordance with one or more embodiments.

FIG. 5 illustrates an example system that includes an example computing device that is representative of one or more systems and/or devices that may implement the various techniques described herein.

### DETAILED DESCRIPTION

Cloning computing device containers is discussed herein. An operating system running on a computing device, also referred to herein as a host device, uses containers for hardware resource partitioning. In contrast to many virtual machine based approaches, containers allow lower runtime overhead and resource demands, and also allow a simpler deployment model for the workloads. Container-based hardware resource partitioning also allows for increased density of programs on a computing device, reducing the facilities, labor, and hardware used to run a particular number of programs.

A container can include one or more of various different components, such as a base operating system (e.g., an operating system kernel), a user-mode environment, an application or program, virtual devices (e.g., processors, memory), combinations thereof, and so forth. Multiple containers can be run on a single computing device. Each container can include its own operating system kernel, or alternatively different containers can share a common operating system kernel. For example, process containers can share the kernel with the host operating system, whereas virtualized containers use their own kernel (and multiple containers can share a kernel).

One or more container templates are maintained for a computing device, and in response to a request to create a new container, a template container is copied into memory of the computing device to create the new container. The template container includes the various components of the container. These components are copied into memory of the computing device rather than being launched or started one after the other. Thus, time need not be expended starting the various components included in the container—the components are just copied into memory as a new container.

The computing device optionally has access to a library of multiple different template containers. Each template container has a different set of components than the other template containers. In response to a request to create a new container, the appropriate one of the multiple template containers is copied into memory of the computing device to create the new container.

In one or more embodiments, the copying of the template container uses a copy-on-write technique. Virtual memory of the new container is initialized to reference the same physical memory as the template container, but the virtual memory is marked as read-only. If the new container (e.g., a component running in the new container) attempts to modify a portion of the virtual memory of the new container, that portion (e.g., one or more memory pages) are copied into new memory pages, creating a private copy of that portion of the virtual memory for the new container. Thus, memory usage is conserved as new memory pages need not be created and/or made available to the new container until an attempt is made to modify the memory pages.

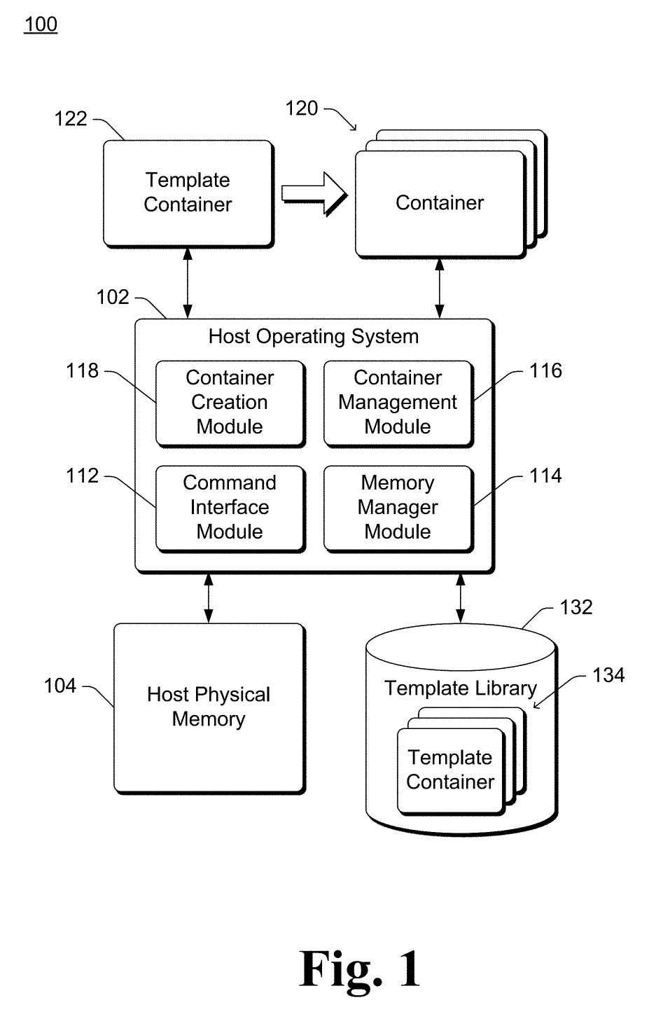

FIG. 1 illustrates an example system 100 implementing the cloning computing device containers in accordance with one or more embodiments. System 100 is implemented at least in part by a computing device. Any of a variety of different types of computing devices can be used to implement the system 100, such as a server computer, a desktop computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, virtual reality glasses or headset, augmented reality headset or glasses), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device implementing system 100 may range from a full resource device with substantial memory and processor resources (e.g., personal computers, game consoles) to a low-resource device with limited memory and/or processing resources (e.g., traditional set-top boxes, hand-held game consoles).

The system 100 includes a host operating system 102 and a host physical memory 104. In one or more embodiments, the host operating system 102 and the host physical memory 104 are implemented as part of the same computing device. Alternatively, at least part of the host physical memory 104 can be implemented on a separate device from the device implementing the host operating system 102.

The host operating system 102 includes a command interface module 112, a memory manager module 114, a container management module 116, and a container creation module 118. The host operating system 102 also manages one or more containers 120. The command interface module 112 receives commands to start and stop a container 120. In one or more embodiments the command interface module 112 is an application programming interface (API) that exposes various methods that can be invoked by a program running the system 100, by an administrator or user of the system 100 (e.g. via a user interface exposed by the system 100), and so forth. These methods can be invoked (e.g., by a program, by an administrator or other user of the system 100) to provide a start command for a container or a stop command for a container. For example, when a program determines that a particular application is to be run (e.g., in response to a user request), that program can provide a start command to the command interface module 112 to have a container running that particular application started.

In one or more embodiments, in response to a start command, the command interface module 112 communicates with the container creation module 118 to create a new container 120. The container creation module 118 creates a new container by “cloning” a template container 122, which refers to copying the template container into memory of the system 100 to create a new container 120. This cloning of the template container 122 is discussed in additional detail below. While the newly created container 120 is running, the container management module 116 manages the container 120, for example determining when the container 120 is to run (i.e., execute). In response to a stop command for a particular container 120, the container management module 116 stops running that particular container 120 and in one or more embodiments deletes that particular container 120. Deletion of a container refers to removing the container 120, including the components of the container, from memory of the system 100. The stop command can be received, for example, from a program running in the system 100 (e.g., a program running within the container itself) in response to the work that a particular container was created to perform (e.g., some calculations, responding to some request, etc.) being completed.

Multiple containers can be run in the system 100 concurrently, and each container includes one or more components. These components include, for example, virtual devices (e.g., one or more processors, memory, storage devices), a base operating system (e.g., an operating system kernel), a user-mode environment, applications, and so forth. A base operating system component provides various different low level system services to components in the container, such as session management, program execution, input/output services, resource allocation, and so forth. The base operating system component can be a full operating system, or alternatively only a portion of a full operating system (e.g., the base operating system component may be a very small component if the container shares most of the operating system with the host (in particular, the kernel)). The user-mode environment component provides a runtime environment for applications in the container (e.g., a Java Runtime Environment, a .NET framework, and so forth). The application component is an application that is desired (e.g., by a user, administrator, other program, etc.) to be run in the container (e.g., a web service, a calculation engine, etc.).

One type of container that a container 120 can be implemented as is referred to as a process container. For a process container, the application processes within the container run as if they were operating on their own individual system (e.g., computing device), which is accomplished using namespace isolation. Host operation system 102 implements namespace isolation. Namespace isolation provides processes in a container a composed view consisting of the shared parts of host operating system 102 and the isolated parts of the operating system that are specific to each container such as filesystem, configuration, network, and so forth.

Another type of container that a container 120 can be implemented as is referred to as a virtualized container. For a virtualized container, the virtualized container is run in a lightweight virtual machine that, rather than having specific host physical memory 104 assigned to the virtual machine, has virtual address backed memory pages. Thus, the memory pages assigned to the virtual machine can be swapped out to a page file. The use of a lightweight virtual machine provides additional security and isolation between processes running in a container. Thus, whereas process containers use process isolation or silo-based process isolation to achieve their containment, virtualized containers use virtual machine based protection to achieve a higher level of isolation beyond what a normal process boundary can provide. A container may also be run in a virtual machine using physical memory 104, and the cloning discussed herein is used to copy the state of the template container into the physical memory used by the new container. Such a container using physical memory allows for higher isolation, e.g., in situations where the use of virtual memory for the virtual machine is not desired because of performance or security concerns.

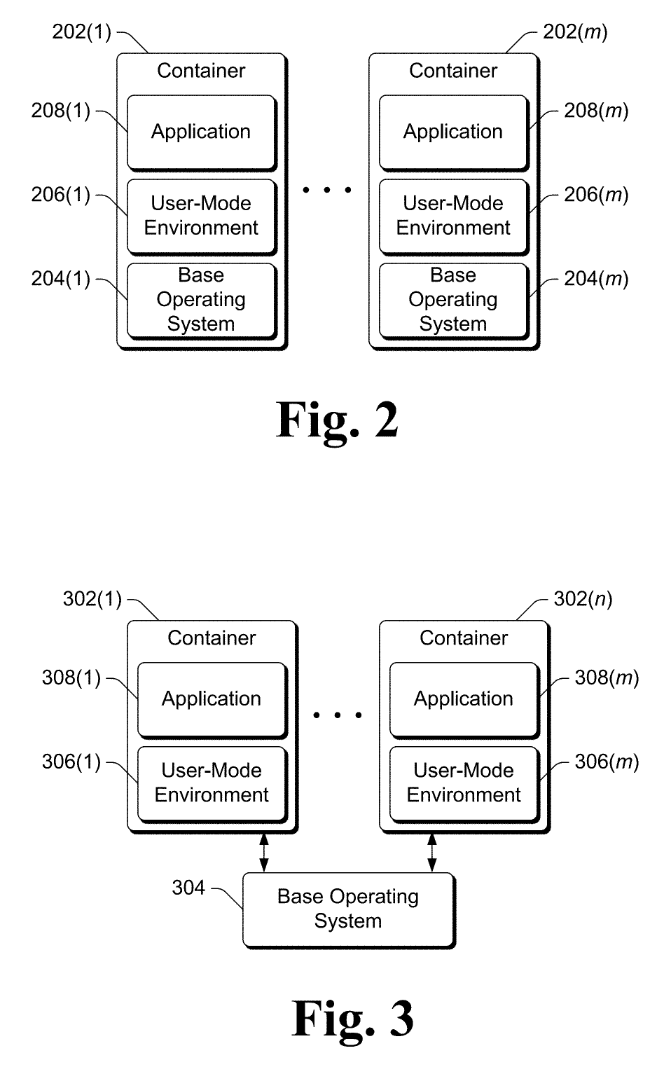

FIG. 2 illustrates multiple (m) example containers 202(1), . . . , 202(m). Each container 202 includes multiple components illustrated as a base operating system (e.g., an operating system kernel) 204, a user-mode environment 206, and an application 208. Although a single application 208 is illustrated in each of the containers 202, it should be noted that a container 202 can include multiple applications. Each container 202 can include the same application 208, or alternatively different containers 202 can include different applications. Similarly, each container 202 can include the same base operating system 204 and the same user-mode environment 206, or alternatively different containers 202 can include different base operating systems and/or different user-mode environments. One or more of the containers 202 can also optionally include various additional components, such as various different virtual devices (e.g., processors, memory, storage devices, and so forth).

The different components of the containers 202 are also referred to as being at different layers or levels. In the illustrated example of FIG. 2, the base operating system 204 is at the lowest layer or level, the user-mode environment 206 is at the next lowest layer or level, and the application 208 is at the highest layer or level. The component at a particular layer is started by or launched from a lower layer (typically the closest lower layer). For example, the user-mode environment 206 is started or launched by the base operating system 204, and the application 208 is started or launched by the user-mode environment 206. These layers or levels typically form a dependency hierarchy (e.g., an application depends on a specific version of a runtime environment (a user-mode environment), and the runtime environment depends on a specific base operating system)—it is usually not possible to replace a lower layer with a different version without invalidating the upper layers.

It should be noted that although the separation of components into base operating system, user-mode environment, and application components is one approach, containers can include a variety of layers. For example, the user-mode environment itself can be constructed from multiple layers. It should also be noted that one characteristic of the layers is that layers at a lower level are typically more generic (e.g., the base operating system), and layers at a higher level are typically more specialized (e.g., the specific application).

FIG. 3 illustrates multiple (n) example containers 302(1), . . . , 302(n). The containers 302 include user-mode environments 306 and applications 308, analogous to the user-mode environments 206 and applications 208 in the example of FIG. 2. However, in the example shown in FIG. 3 a base operating system 304 (e.g., an operating system kernel) is shared by the containers 302. Thus, rather than the base operating system being included as part of each container as illustrated in the example of FIG. 2, a single base operating system is shared by the multiple containers in the example of FIG. 3.

Although a single application 308 is illustrated in each of the containers 302, it should be noted that a container 302 can include multiple applications. Each container 302 can include the same application 308, or alternatively different containers 302 can include different applications. Similarly, each container 302 can include the same user-mode environment 306, or alternatively different containers 302 can include different user-mode environments. One or more of the containers 302 can also optionally include various additional components.

Similar to the discussion of FIG. 2, the different components of the containers 302 are also referred to as being at different layers or levels. In the illustrated example of FIG. 3, the user-mode environment 306 is at the lowest layer or level and the application 308 is at the highest layer or level. The component at a particular layer is started by or launched from a lower layer (typically the closest lower layer). For example, the application 308 is started or launched by the user-mode environment 306. The user-mode environment 306 of each container 302 is started or launched by the base operating system 304. Although not part of the containers 302, the base operating system can also be referred to as being at a lower layer or level than the user-mode environments 306.

Returning to FIG. 1, the memory manager module 114 manages the host physical memory 104 using virtual memory and paging. Virtual memory refers to having a virtual address space for different programs running in the system 100 (e.g., different containers 120), and different portions of that virtual memory are mapped to various portions of the physical memory 104 at different times. Paging refers to the memory manager module 114 organizing the physical and virtual memory into pages, which are a particular (e.g., fixed) size unit of data. The act of paging refers to reading data in units of pages from a backing file (e.g., stored on a hard drive or other storage device of the system 100) when the data is not in the host physical memory 104. The act of paging also refers to writing dirty (modified) data back in units of pages into the page file. The memory pages are thus also referred to as page file backed memory pages. Such virtual memory and paging techniques are well known to those skilled in the art.

The template container 122 is loaded into memory of the system 100 by the host operating system 102. In one or more embodiments, the template container 122 is loaded into memory by the memory manager module 114 assigning a virtual address space to the template container 122, and the container creation module 118 starting or launching at least one component in the address space of that container. For example, the container creation module 118 starts or launches a base operating system in the template container 122, that base operating system starts or launches a user-mode environment in the template container 122, and that user-mode environment starts or launches an application in the template container 122.

Alternatively, the template container 122 can be loaded into memory of the system 100 in different manners. For example, an image of the template container 122 can be stored on a storage device (e.g., a hard disk drive of the system 100), the image of the template container 122 being a copy or view of the template container 122 as the template container exists in an address space. The template container 122 is loaded into memory by the memory manager module 114 assigning a virtual address space to the template container 122, and the container creation module 118 copying the image of the template container 122 into that address space.

In one or more embodiments, the template container 122 serves as a template from which other containers 120 can be created. Thus, although the template container 122 may include one or more applications that can be run (e.g., to provide various services or calculations), such applications typically are not run in the template container 122 (except as used to start or launch components in another layer, if any). After start-up, the memory state for the template container includes all of the running software for all components (e.g., the base operating system, the user-mode environment, and the application). Execution of this first container is then suspended, but its runtime state is kept in memory, and thus can be copied for new containers as discussed below.

To create a new container 120, the template container 122 is cloned, which refers to copying the template container 122 into memory of the system 100 to create the new container 120.

The memory manager module 114 assigns a virtual address space to the new container 120, and the container creation module 118 copies the template container 122 into the virtual address space of the new container 120. Thus, rather than starting or launching components one by one in the address space of the new container 120, the components as they exist in the template container 122 are copied into the new container 120. The new container 120 can be started almost immediately and does not need to wait for software (e.g., applications) of the new container to be started because it can take advantage of the fact that the template container already started this software and the container creation module 118 is making a copy of the state of the template container 122.

Copying the template container 122 into the virtual address space of the new container 120 refers to copying the state of the template container 122 into the virtual address space of the new container 120. The state of the template container 122 includes the memory state associated with the template container 122. The template container 122 may have generated hundreds of megabytes of memory state as part of its initialization when starting the various levels of software as described above, and this memory state is copied into the virtual address space of the new container 120. The state of the template container 122 can also include additional state, which can vary based on the manner in which the containers are implemented. For example, if the containers 120 include virtual devices (e.g., processors), then the state of the template container 122 also includes the state of those virtual devices. By way of another example, the state of the template container 122 can include the state of network connections created by the processes running in the template container 122, a list of files opened by the processes running in the template container 122, and so forth. By way of another example, if the containers 120 include a base operating system component, then the state of the template container includes various operating system kernel data associated with the template container 122.

In one or more embodiments, the template container 122 is cloned by copying all of the state of the template container 122 into the virtual address space of the new container 120, allowing the new container 120 to run. For example, all of the state of the template container 122 that is required to run the new container 120 is copied to the new container 120.

Additionally or alternatively, the container creation module 118 leverages a copy-on-write technique when copying the state of the template container 122. Using the copy-on-write technique, the actual memory contents of the template container 122 are not copied immediately. Instead, the virtual memory of the new container 120 is initialized to reference the same memory that is being used for the template container 122 (e.g., the same physical memory, or virtual memory used by the template container 122). The virtual memory of the new container 120, however, references the memory state of the template container 122 as read-only. After the new container 120 is started, the new container 120 can directly access the memory state of the template container 122, but the new container 120 can only read the memory state of the template container 122. In response to the new container 120 attempting to modify a portion of the memory state of the new container 120 during execution of the new container 120, the new container 120 takes a page fault and the memory manager module 114 provides the new container 120 with its own private copy of the portion of memory state from the template container 122. The new container 120 has write and/or modify permission to the private copy, allowing the new container 120 to make the desired change to the memory state of the new container 120.

When using the copy-on-write technique, because the new container 120 only gets read-only access to the memory state of the template container 122, multiple new containers can all share the memory state of the template container 122 simultaneously. Thus, leveraging copy-on-write capabilities associated with virtual memory makes container start-up faster because memory contents do not actually have to be copied. This also allows for better memory density, as multiple containers 120 can share the memory of the template container 122.

In one or more embodiments, the system 100 includes a template library 132 that includes multiple template containers 134. The template library can be implemented on any of a variety of types of storage devices, such as a magnetic disk drive, an optical disc drive, a solid-state drive (SSD), and so forth. The template library can also be stored on removable or remote storage devices. Such a removable or remote storage device can communicate with the computing device implementing the host operating system 102 using a wired or wireless connection, such as a USB (universal serial bus) connection, a wireless USB connection, an infrared connection, a Bluetooth connection, a DisplayPort connection, a PCI (a peripheral component interconnect) Express connection, and so forth. Such a removable or remote storage device can alternatively or additionally communicate with the computing device implementing the host operating system 102 via a data network, such as the Internet, a local area network (LAN), a public telephone network, an intranet, other public and/or proprietary networks, combinations thereof, and so forth. The removable or remote storage device may alternatively or additionally implement a file server, a distributed filesystem and so forth.

Each of the template containers 134 is different, including different components (e.g., different applications). Each of the template containers 134 can be loaded into memory of the system 100 analogous to the template container 122 discussed above. In response to a request to create a container, the container creation module 118 determines an appropriate one of the template containers 134 to clone to create the new container. This determination can be made in different manners, such as based on the components that the requested container include. For example, if the request to create a container indicates that the container is to run a particular application, then the container creation module 118 selects the template container 134 that includes as a component that particular application. By way of another example, if the request to create a container indicates that the container is to run a particular operating system and/or user-mode environment, then the container creation module 118 selects the template container 134 that includes as a component that particular operating system and/or user-mode environment.

In one or more embodiments, the template container selected by the container creation module 118 to clone for a new container does not include all of the components requested or desired for the new container. In such situations, the template container is cloned, and then additional components are started or launched in the new container as appropriate. For example, a template container may include a base operating system component and a user-mode environment component, but no application components. In response to a request to create a new container to run a particular application, the template container is cloned to create the new container, and then the particular application is started or launched by the user-mode environment component in that new container. This reduces the number of template containers that are maintained in the template library, allowing different containers running different applications to be created by cloning the template container and then starting or launching the desired application for an individual container. Although the applications are started or launched in each new container, time need not be expended in starting or launching the base operating system or user-mode environment because the base operating system and user-mode environment components are copied from the template container.

By way of another example, a template container may include a base operating system component, but no user-mode environment component and no application components. In response to a request to create a new container to run a particular application with a particular user-mode environment, the template container is cloned to create the new container, and then the particular user-mode environment is started or launched in that new container by the base operating system component, and the particular application is started or launched by the user-mode environment component in that new container. This reduces the number of template containers that are maintained in the template library, allowing different containers running different applications and/or different user-mode environments to be created by cloning the template container and then starting or launching the desired user-mode environment and application for an individual container. Although the applications and user-mode environments are started or launched in each new container, time need not be expended in starting or launching the base operating system because the base operating system component is copied from the template container.

In one or more embodiments, changes to resource configurations of a container 120 can be made to the container 120 after it is created (e.g., the template container has been cloned). These resource configurations can include, for example, the number of virtual processors in the container 120, the amount of memory used by the container 120, input/output used by the container 120, and so forth. The resource configuration changes can be performed by, for example, the container creation module 118 or the container management module 116. These changes, because they are made after the container starts, are also referred to as hot changes or dynamic changes to the container.

Alternatively, or in addition to modifying the resource configuration of the container 120, the container 120 might also be reconfigured in order to meet the specific needs of the application that that will be started in the container 120. For example, if the application requires access to a specific storage device, the container 120 will be re-configured to allow access to the storage device. By way of another example, if the application requires access to a specific network interface, the container 120 will be re-configured to allow access to the network interface.

Performing these resource control changes after a container is created allows the same template container to be used for new containers having different resource configurations. For example, the template container may include four virtual processors, but a new container desires only two virtual processors. The template container can be cloned and the new container created with four virtual processors, and then dynamically changed to include only two virtual processors.

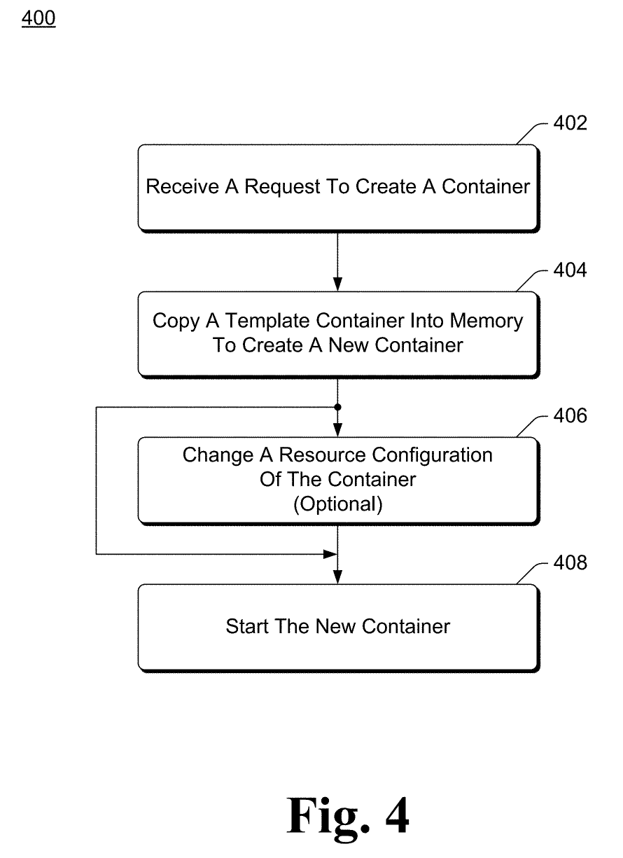

FIG. 4 is a flowchart illustrating an example process 400 for cloning computing device containers in accordance with one or more embodiments. Process 400 is carried out by a system, such as system 100 of FIG. 1, and can be implemented in software, firmware, hardware, or combinations thereof. Process 400 is shown as a set of acts and is not limited to the order shown for performing the operations of the various acts. Process 400 is an example process for cloning computing device containers; additional discussions of cloning computing device containers are included herein with reference to different figures.

In process 400, a request to create a container is received (act 402). This request can be received from various different sources as discussed above, such as a user or administrator of the system, another program, another device, and so forth. This request is, for example, a start command requesting that the container start running.

A template container is copied into memory to create a new container (act 404). Thus, rather than creating the new container by launching or starting each component in the new container, at least some of the state of new container is obtained by copying state from the template container.

A resource configuration of the container is optionally changed (act 406). This resource configuration change can be the changing of various different resource configurations for the newly created container, such as a number of virtual processors in the newly created container, and amount of memory used by the newly created container, and so forth.

The new container is started (at 408). Starting the new container refers to beginning running the components in the new container to perform the tasks or work desired for the new container.

Thus, using the techniques discussed herein, container start-up time is reduced, allowing containers to start-up quickly and thus enabling deployment models like micro-services where containers are synchronously launched in response to a client request. Furthermore, the copy-on-write techniques discussed above increase density and reduce memory resource requirements for containers. Increased density reduces operating cost by running more containers on a system and thus reducing the number of systems used to host a container-based workload.

The techniques discussed herein leverage the realization that various components for containers (e.g., the runtime environment for container) is the same across multiple containers. Rather than launching a new container by starting the runtime environment for a container, the techniques discussed herein take an existing container that has started (referred to as the template container) and cloning that existing container in order to start additional containers.

Additional discussion of one type of container, a virtualized container, is included in the following. It should be noted that the following discussion includes examples of virtualized containers, and that other techniques for implementing virtualized containers can additionally or alternatively be used.

Some embodiments described herein (e.g., embodiments using virtualized containers) use virtual memory allocated from a user-mode process on the host device (or other virtual memory allocation) to back a container's memory rather than using non-paged physical memory allocations on the host. This allows the host kernel's memory management (e.g., the memory manager module 114 of FIG. 1) to manage the host physical memory associated with the container's memory. In particular, memory management logic that already exists in the host (e.g., the host operating system 102) can be leveraged to manage the container's memory. This can allow for the use of a smaller hypervisor (also referred to as a virtual machine monitor), in terms of the amount of code used to implement the hypervisor. A smaller hypervisor, which is the trusted portion between the host operating system and the containers in one or more embodiments, can be more secure than larger hypervisors as there is less code that can be exploited or that may have errors. Further, this allows for increased density on the host. Embodiments can use existing logic in a host memory manager module to increase virtual machine density on the host by using less host physical memory than previously used to implement virtual machines.

In one or more embodiments, a user mode process is implemented in a host portion of the system 100 to provide virtual memory for backing containers in a guest portion of the system 100. For example, a user mode process can be created for each container 120. Each such user mode process can be a process that can be managed by the memory manager module 114.

Regular virtual memory in the address space of a designated user mode process that will host the virtual machine for a container is allocated. The host memory manager 114 can treat this memory as any other virtual allocation, which means that it can be paged, the physical page backing it can be changed (e.g., for the purposes of satisfying contiguous memory allocations elsewhere on the system), the physical pages can be shared with another virtual allocation in another process (which in-turn can be another virtual machine backing allocation or any other allocation on the system), and so forth. Additionally, variations are possible to have the memory manager module 114 treat the virtual machine backing virtual allocations specially as appropriate.

A hypervisor (e.g., running on or implemented as part of the host operating system 102) can manage the guest physical memory address ranges by utilizing SLAT (Second Level Address Translation) features in the hardware. The SLAT for a container is updated with the host physical memory pages that are backing the corresponding guest physical memory pages.

Thus, physical address space for a virtualized container is backed by host virtual memory (typically allocated in a host process' user address space), which is subject to regular virtual memory management by the memory manager module 114. Virtual memory backing the virtual machine's physical memory can be of any type supported by the memory manager module 114 (private allocation, file mapping, page file-backed section mappings, large page allocation, etc.). The memory manager 114 can perform its existing operations and apply policies on the virtual memory and/or apply specialized policies knowing that the virtual memory is backing a container's physical address space as necessary.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

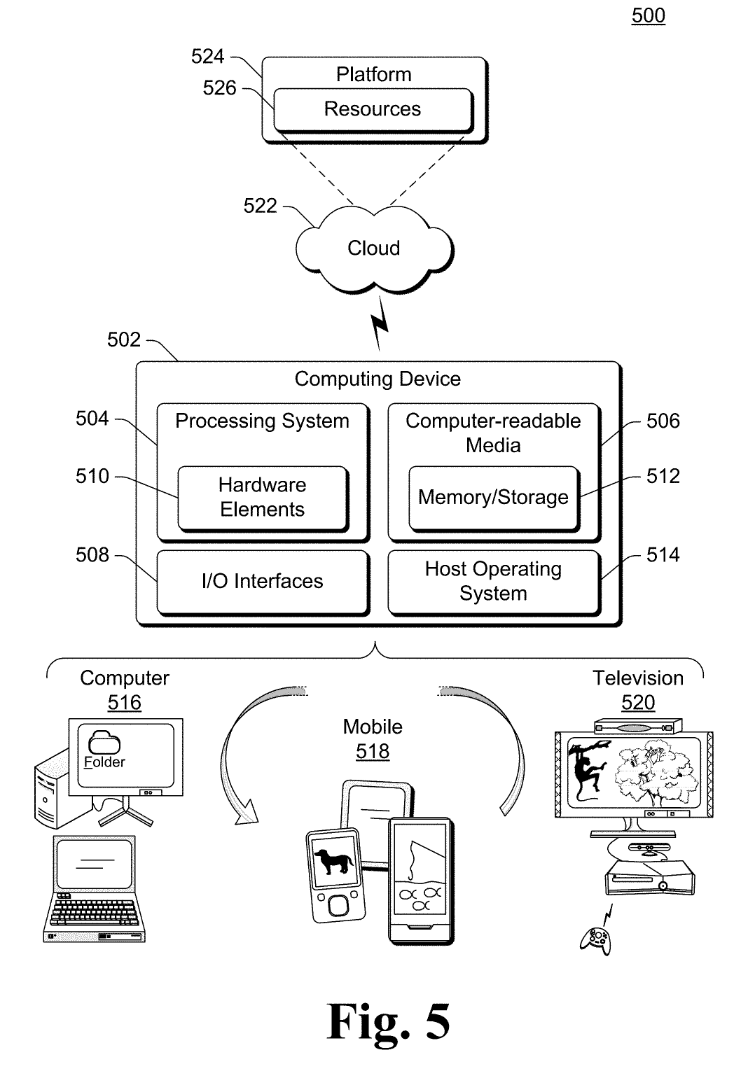

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes a host operating system 514. The host operating system 514 provides various functionality supporting cloning computing device containers as discussed herein. The host operating system 514 can implement, for example, the host operating system 102 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method comprising: receiving a request to create a container in a computing device, the request comprising a start command indicating to start running the created container; copying, in response to the start command, a template container into memory of the computing device to create a new container that is to be the created container; and starting, in response to the start command, the new container.

Alternatively or in addition to any of the above described methods, any one or combination of: the copying including loading into the new container additional state used to run the new container; the copying comprising initializing virtual memory of the new container to reference the same memory as is being used by the template container, marking the references of the new container to the memory of the template container as being read-only, and in response to an attempt by the new container to modify a portion of the memory state of the new container, creating a private copy of the accessed portion of the memory state that can be modified by the new container; the new container including one or more base operating system components; the new container further including one or more user-mode environment components; the new container further including one or more application components; the new container including a user-mode environment component, and sharing a base operating system component with one or more additional containers in the computing device; the computing device further comprising a template library storing multiple template containers, the method further comprising determining an appropriate one of the multiple template containers to use as the template container to copy to create the new container; one of the multiple template containers including as a component a first application, and another of the multiple template containers including as a component a second application that is different than the first application; the method further comprising changing, after creating the new container, a resource configuration of the new container; the changing the resource configuration comprising changing a number of virtual processors in the new container; the changing the resource configuration comprising changing an amount of memory in the new container; the method further comprising changing, after creating the new container, a configuration of the new container based on needs of an application included in the new container.

A system comprising: a command interface module configured to receive a request to create a container in a computing device, the request comprising a start command indicating to start running the created container; and a container creation module configured to copy, in response to the start command, a template container into memory of the computing device to create a new container that is to be the created container, and further configured to start, in response to the start command, the new container.

Alternatively or in addition to any of the above described computing devices, any one or combination of: the new container including a user-mode environment component, and the system sharing a base operating system component of the system with one or more additional containers in the computing device; the system further comprising a template library storing multiple template containers, the container creation module further configured to determine an appropriate one of the multiple template containers to use as the template container to copy to create the new container; the system further comprising a container management module configured to change, after creating the new container, a resource configuration of the new container; the copying comprising initializing virtual memory of the new container to reference the same memory as is being used by the template container, marking the references of the new container to the memory of the template container as being read-only, and in response to an attempt by the new container to modify a portion of the memory state of the new container, creating a private copy of the accessed portion of the memory state that can be modified by the new container.

A computing device comprising: one or more processors; a computer-readable storage medium having stored thereon multiple instructions that, responsive to execution by the one or more processors, cause the one or more processors to: receive start command requesting that a container in the computing device be created; copying, in response to the start command, a template container into memory of the computing device to create a new container; and starting, in response to the start command, the new container as the requested container.

Alternatively or in addition to any of the above described computing devices, any one or combination of: the computing device further comprising a template library storing multiple template containers, the multiple instructions further causing the one or more processors to determine an appropriate one of the multiple template containers to use as the template container to copy to create the new container.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
receiving a request to create a container in a computing device, the request comprising a start command indicating to start running the created container;
copying, in response to the start command, a template container into memory of the computing device to create a new container that is to be the created container; and
starting, in response to the start command, the new container.

2. The method as recited in claim 1, the copying including loading into the new container additional state used to run the new container.

3. The method as recited in claim 1, the copying comprising:
initializing virtual memory of the new container to reference the same memory as is being used by the template container;
marking the references of the new container to the memory of the template container as being read-only; and
in response to an attempt by the new container to modify a portion of the memory state of the new container, creating a private copy of the accessed portion of the memory state that can be modified by the new container.

4. The method as recited in claim 1, the new container including one or more base operating system components.

5. The method as recited in claim 4, the new container further including one or more user-mode environment components.

6. The method as recited in claim 5, the new container further including one or more application components.

7. The method as recited in claim 1, the new container including a user-mode environment component, and sharing a base operating system component with one or more additional containers in the computing device.

8. The method as recited in claim 1, the computing device further comprising a template library storing multiple template containers, the method further comprising determining an appropriate one of the multiple template containers to use as the template container to copy to create the new container.

9. The method as recited in claim 8, one of the multiple template containers including as a component a first application, and another of the multiple template containers including as a component a second application that is different than the first application.

10. The method as recited in claim 1, further comprising changing, after creating the new container, a resource configuration of the new container.

11. The method as recited in claim 10, the changing the resource configuration comprising changing a number of virtual processors in the new container.

12. The method as recited in claim 10, the changing the resource configuration comprising changing an amount of memory in the new container.

13. The method as recited in claim 1, further comprising changing, after creating the new container, a configuration of the new container based on needs of an application included in the new container.

14. A system comprising:
a command interface module configured to receive a request to create a container in a computing device, the request comprising a start command indicating to start running the created container; and
a container creation module configured to copy, in response to the start command, a template container into memory of the computing device to create a new container that is to be the created container, and further configured to start, in response to the start command, the new container.

15. The system as recited in claim 14, the new container including a user-mode environment component, and the system sharing a base operating system component of the system with one or more additional containers in the computing device.

16. The system as recited in claim 14, the system further comprising a template library storing multiple template containers, the container creation module further configured to determine an appropriate one of the multiple template containers to use as the template container to copy to create the new container.

17. The system as recited in claim 14, further comprising a container management module configured to change, after creating the new container, a resource configuration of the new container.

18. The system as recited in claim 14, the copying comprising:
initializing virtual memory of the new container to reference the same memory as is being used by the template container;
marking the references of the new container to the memory of the template container as being read-only; and
in response to an attempt by the new container to modify a portion of the memory state of the new container, creating a private copy of the accessed portion of the memory state that can be modified by the new container.

19. A computing device comprising:
one or more processors;
a computer-readable storage medium having stored thereon multiple instructions that, responsive to execution by the one or more processors, cause the one or more processors to:
receive start command requesting that a container in the computing device be created;
copying, in response to the start command, a template container into memory of the computing device to create a new container; and
starting, in response to the start command, the new container as the requested container.

20. The computing device as recited in claim 19, the computing device further comprising a template library storing multiple template containers, the multiple instructions further causing the one or more processors to determine an appropriate one of the multiple template containers to use as the template container to copy to create the new container.
